(19) United States
(12) Patent Application Publication
(10) Pub. No.: US 2025/0200411 A1
(43) Pub. Date: Jun. 19, 2025

(54) Fast Reset of Qubits for Quantum Computing Systems

(71) Applicant: Google LLC, Mountain View, CA (US)

(72) Inventors: Kevin Chenghao Miao, Goleta, CA (US); Nicholas Reinhard Zobrist, Santa Barbara, CA (US); Charles James Neill, Goleta, CA (US); Ofer Naaman, Santa Barbara, CA (US)

(21) Appl. No.: 18/538,622

(22) Filed: Dec. 13, 2023

(51) Int. Cl. G06N 10/40

(52) U.S. Cl. CPC G06N 10/40

(57) ABSTRACT

The disclosure is directed to a quantum processor system. The system includes a transmission line, a resonator, a qubit coupled to the resonator, and a switching device that couples and decouples the resonator to the transmission line. The resonator stores a range of energies based on a frequency that characterizes the resonator. When a quantum state of the qubit is equivalent to an excited state and the qubit is tuned in accordance with the frequency, energy is transferred from the qubit to the resonator, which stores the energy. The quantum state of the qubit is transitioned to a ground state. When the switching device is closed, the resonator is coupled to the transmission line such that the energy is transferred to the transmission line. When the switching device is opened, the resonator is decoupled from the transmission line.

### FIELD

The present disclosure relates generally to quantum computing and information processing systems, and more particularly to the fast reset of qubits for quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0>+b|1> The “0” and “1” states of a digital computer are analogous to the |0> and |1> basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a quantum processor system (e.g., a quantum computing system and/or a quantum information processing system). The system may include a transmission line, a first energy-storage device, a first qubit, and a first switching device. The first energy-storage device is configured to store a first range of energies based on a first frequency that characterizes the first energy-storage device. The first qubit is electrically coupled to the first energy-storage device. When a quantum state of the first qubit is equivalent to a second state and the first qubit is tuned in accordance with the first frequency, a first quantum of energy is transferred from the first qubit to the first energy-storage device. The first energy-storage device stores the first quantum of energy. The quantum state of the first qubit is transitioned from the second state to a first state. An energy difference between the second state and the first state is equivalent to the first quantum of energy. The first switching device is electrically coupled to the first energy-storage device. When the first switching device is tuned to a first operational state, the first energy-storage device is further electrically coupled to the transmission line such that the first quantum of energy stored by the first energy-storage device is transferred to the transmission line. When the first switching device is tuned to a second operational state, the first energy-storage device is electrically decoupled from the transmission line.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 provides a schematic view of a conventional multi-stage cryogenic system and a conventional architecture typically employed to thermalize the signal lines and attenuate signals in a quantum computing system;

FIG. 1 depicts an example quantum computing system according to example embodiments of the present disclosure;

FIG. 2 provides a schematic view of at least a portion of a quantum computing system, according to various embodiments;

FIG. 3A depicts a flow chart diagram of an example method for operating a quantum computing system, according to example embodiments of the present disclosure; and

FIG. 3B depicts a flow chart diagram of an example method for resetting a first qubit and a second qubit to their ground states, according to example embodiments of the present disclosure.

### DETAILED DESCRIPTION

Example aspects of the present disclosure are directed to methods, architectures, and hardware configurations that enable the fast reset of qubits in a quantum computing system. Quantum error correction (QEC) algorithms that make use of stabilizer measurements (e.g., surface codes and color codes) typically involve an array of qubits encoding the quantum information (“data qubits”) interspersed with qubits that periodically and repeatedly perform checks on the encoded information (“measure qubits”). These checks may be performed by applying quantum logic operations (e.g., a CNOT operation) on the data and measure qubits and culminate in measurement of the measure qubits. At the end of measurement, the state of the measure qubits is effectively random, and must be reinitialized before the next round of checks can be performed.

In the various embodiments, a set of qubits, a set of energy-storage devices (e.g., resonators), a set of switching devices, and a transmission line are integrated on a semiconductor substrate. There may be a one-to-one correspondence between the qubits of the set of qubits and the energy storage devices of the set of energy-storage devices. Each qubit may be electrically coupled to its corresponding energy-storage device. In at least one embodiment, the electrical coupling between a qubit and its corresponding energy-storage device may be a capacitive coupling via a capacitor between the qubit and corresponding energy-storage device. There may be a one-to-one correspondence between the energy-storage devices of the set of energy-storage devices and the switching devices of the set of switching devices. Each energy-storage device may be electrically coupled to its corresponding switching device. A switching device may function to selectively electrically couple and decouple its corresponding energy-storage device to the transmission line. That is, in a first mode of operation (e.g., a closed mode), the switching device electrically couples its corresponding energy-storage device to the transmission line. In a second mode of operation (e.g., an open mode), the switching device electrically decouples its corresponding energy-storage device from the transmission line. When the switching device couples its corresponding energy-storage device to the transmission line, the transmission line is enabled to transmit energy stored in the energy-storage device off the semiconductor substrate, where it may be safely dissipated “off-chip.” In various embodiments of a quantum computing system, the semiconductor substrate may be located in a cryogenic chamber of the quantum computing system.

To reinitialize the measure qubits, a qubit reset operation removes excitations associated with excited states (e.g., |1>) from the measure qubit and restores the qubit to its ground state (e.g., |0>). In some embodiments, the reset operation involves swapping energy associated with qubit excitations (e.g., an energy difference between an excited state and the qubit's ground state) from the qubit to it corresponding energy-storing device (e.g., a resonator). Upon transferring energy associated with an excited state to the qubit's corresponding energy-storage device, the qubit is transitioned to its ground state. This energy transfer from the qubit to its corresponding energy-storage device may be enabled by tuning the qubit to a resonant frequency of the energy-storage device. The energy associated with the qubit excitations are stored temporarily by the energy-storage device. The energy-storage device's (and hence the qubit's) corresponding switching device selectively couples and decouples the energy-storage device to the transmission line, which leads “off-chip.” After the energy associated with the qubit excitations has been transferred to the energy-storage device, the corresponding switching device may be activated to electrically couple the energy-storage device with the transmission line. Upon this coupling, the energy stored in the energy-storage device may be transmitted to the transmission line, and transmitted to be dissipated off-chip. In various embodiments, the switching devices may be superconducting quantum interference devices (SQUIDs) couplers.

In contrast to the embodiments, previous methods and architectures for resetting a qubit require at least about 160 ns to reset a measure qubit. To achieve a scalable quantum computing system, given errors rates for current qubit implementations, a QEC algorithm would require the measure qubits reset cycle to be about 50 ns, or less. The embodiments achieve about 50 ns (or less) reset cycles, and thus provide for scalable quantum computing systems. Furthermore, these previous qubit reset methods (and architectures) are prone to crosstalk between resonators through their shared coupling to the external environment. Herein, crosstalk between neighboring qubits may refer to at least a portion of energy associated with one qubit being unintentionally transferred to another qubit. The embodiments achieve about 50 ns (or less) reset operations and significantly decrease crosstalk by decreasing crosstalk between the energy-storage devices (e.g., resonators). The crosstalk is reduced between neighboring energy-storage devices by decoupling the energy-storage devices from the transmission line via the switching devices. The crosstalk issue is further reduced by having different resonant frequencies for neighboring energy-storage devices.

Aspects of the present disclosure provide a number of technical effects and benefits. For instance, as discussed below, the embodiments enable a “fast” reset of the qubits, where fast be may a reset achieved in 50 ns or less. Furthermore, the embodiments reduce crosstalk between neighboring energy-storage devices during a qubit reset. That is, the embodiments achieve both a fast reset speed and reduce crosstalk by introducing a coupling circuit which induces loss in the energy-storage device when the switching device electrically couples its corresponding electrical-storage device, and protects the energy-storage device from crosstalk by employing the switching device to decouple the energy-storage device from the transmission line. The fast reset may be achieved by employing the switching device to decouple its corresponding energy-storage device from the transmission line. Once decoupled, the corresponding qubit may be tuned to enable a transfer of its excitations to its energy-storage device. As noted above, when the energy-storage device is decoupled from the transmission line, the energy-storage device and the corresponding qubit are isolated from the environment and are thus protected from crosstalk. After isolating the qubits, the switching devices may be coupled to the transmission line via the switching devices. The energy-storage devices are then in a “lossy” state and can transfer their temporally stored energy to the environment. That is, in this lossy state, the energy-storage devices may quickly flush the qubits' excitations to the environment, via the transmission line.

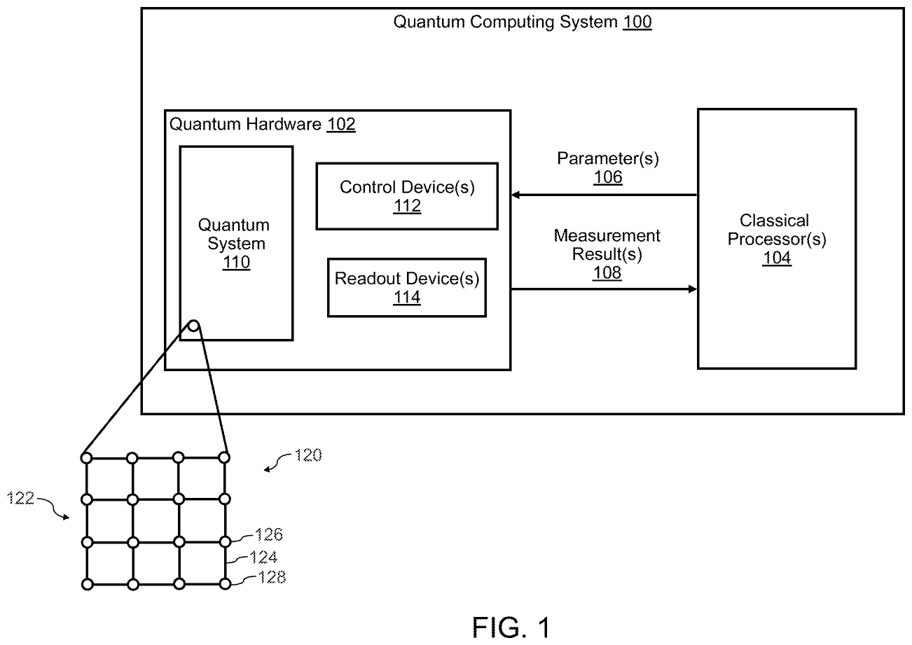

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0> and |1> states of an element of the quantum system, such as a qubit, to measure the state of the element (e.g., the qubit). For example, the resonance frequency of a readout resonator can take on different values when a qubit is in the state |0> or the state |1>, due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit t. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.
QCS 200 includes a cryogenic chamber 210 and a semiconductor substrate 220 positioned within the cryogenic chamber 210. The semiconductor substrate 220 may be a semiconductor device and/or a semiconductor chip. The semiconductor substrate 2220 may be a packaged or an unpackaged semiconductor device and/or chip. A set of qubits is integrated on the semiconductor substrate 220. When executing a quantum algorithm, the QCS 200 may implement a quantum error correction (QEC) code, e.g., a surface code or a color code. The QCS 200 may employ at least a subset of the set of qubits may measure (or ancilla) qubits. As such, when a measure qubit is measured during the execution of the QEC, the measure qubit may be reset to its ground state, e.g., |0> in the Z-basis. As described below, the QCS 200 is enabled to perform a fast reset qubits, without (or at least reduced) crosstalk between the qubits. Crosstalk between qubits may refer to at least a portion of energy associated with one qubit being unintentionally transferred to another qubit.

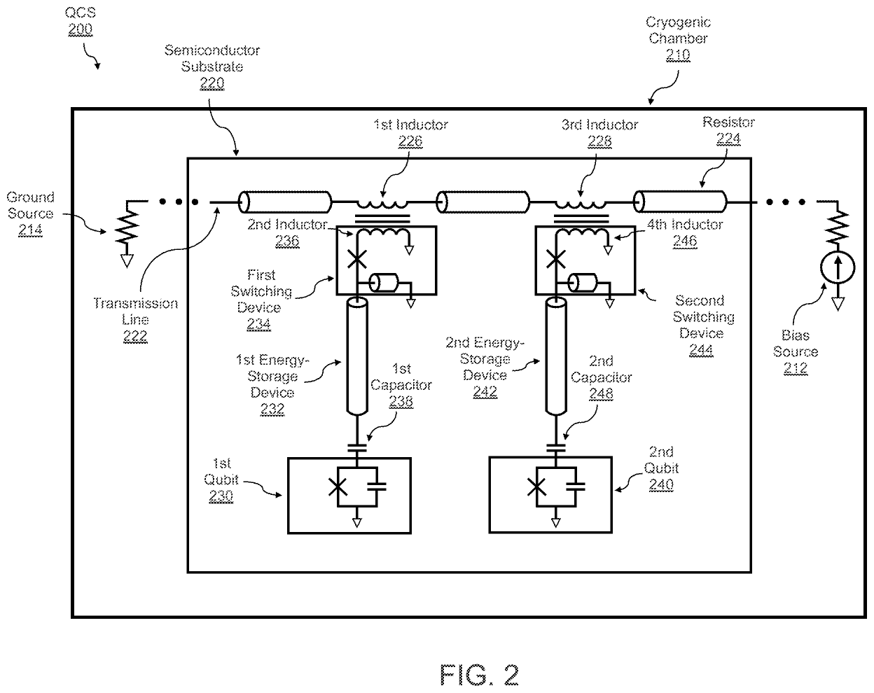

For illustrative purposes, a first qubit 230 and a second qubit 240 of the set of qubits are shown integrated on the semiconductor substrate 220 in FIG. 2. In other embodiments, the set of qubits may include many additional qubits not shown explicitly integrated on the semiconductor substrate 220. Although the embodiments are not so limited, in FIG. 2, the first qubit 230 and the second qubit 240 are shown as superconducting transmon qubits. In other embodiments, the qubits may be implemented via other quantum technologies (e.g., fluxonium qubits). At least one of the first qubit 230 and/or the second qubit 240 may be a measure qubit. Accordingly, QCS 200 is enabled to perform a fast reset on at least one of the first qubit 230 and/or the second qubit 240, as described below.

A transmission line 222 is integrated on the semiconductor substrate 220. The transmission line 222 may be enabled to transmit one or more electrical (e.g., voltage and/or current) signals along the transmission line 222. Each qubit of the set of qubits is electrically coupled to the transmission line 222 via a separate energy-storage device, a separate switching device, and an inductor. For instance, as shown in FIG. 2, the first qubit 230 is electrically coupled to a first energy-storage device 232, via a first capacitor 238. Thus, the first capacitor 238 capacitively couples the first qubit 230 to the first energy-storage device 232. The first energy-storage device 232 is electrically coupled to the first switching device 234. When the first switching device is “closed,” the transmission line 222 is electrically coupled (e.g., inductively coupled) to the first switching device 234 via a first pair of inductors: first inductor 226 (e.g., integrated on the transmission line 222) and a second inductor 236 (e.g., integrated in the first switching device 234). Thus, the transmission line 222 and the first switching device 234 may be inductively coupled when a signal (e.g., a current) is transmitted along the transmission line 222, via the first inductor pair (e.g., the first inductor 226 and the second inductor 236).

Likewise, the second qubit 240 is electrically coupled to a second energy-storage device 242, via a second capacitor 248. Thus, the second capacitor 248 capacitively couples the second qubit 240 to the second energy-storage device 242. The second energy-storage device 242 is electrically coupled to the second switching device 244. When the second switching device 244 is “closed,” the transmission line 222 is electrically coupled (e.g., inductively coupled) to the second switching device 234 via a second pair of inductors: third inductor 228 (e.g., integrated on the transmission line 222) and the fourth inductor 246 (e.g., integrated in the second switching device 244). Thus, the transmission line 222 and the second switching device 244 may be inductively coupled when a signal (e.g., a current) is transmitted along the transmission line 222, via the second inductor pair (e.g., the third inductor 228 and the fourth inductor 246).

Each qubit of the set of qubits that is integrated on the semiconductor substrate 220 may be similarly coupled to the transmission line in a similar manner as first qubit 230 and second qubit 240. For instance, each qubit of the set of qubits may have its own device pair (an energy-storage device and a tunable coupling device). As also shown in FIG. 2, to regulate signals being transmitted along the transmission line 222, one or more resistors (e.g., resistor 224) may be placed on the transmission line 222. In some embodiments, there may be a resistor placed between each consecutive pairs of switching devices, as implicitly implied by FIG. 2. The values of the resistors may be equivalent, similar, or dissimilar, depending on the specifics of the signals transmitted along the transmission line. In a non-limiting embodiment, each resistor has an impedance of about 50Ω. In some embodiments, the QCS 200 may additionally include a bias source 212 (e.g., a voltage source) and a ground source 214. The bias source 212 and the ground source 214 may be located off-chip, e.g., not located on the semiconductor substrate 220. In at least one embodiment, even though the bias source 212 and the ground source 214 are not located on-chip (e.g., not integrated on the semiconductor substrate 220), they may each be located within the cryogenic chamber 210. In other embodiments, at least one of the bias source 212 and/or the ground source 214 may be located outside of the cryogenic chamber 210.

In some embodiments, the energy-storage devices (e.g., first energy storage device 232 and/or the second energy-storage device 242) may be resonators, e.g., a quarter-wavelength resonator. Thus, the first energy-storage device 232 may be a first resonator device (e.g., a first quarter-wavelength resonator) and the second energy-storage device 242 may be a second resonator device (e.g., a second quarter-wavelength resonator). Other embodiments are not so limited, and the energy-storage devices may be any device that can receive energy transferred from its respective qubit, and at least temporally store the energy transferred from the qubit, via its capacitive coupling with the qubit. In resonator embodiments, each resonator (e.g., first energy-storage device 232 and second energy-storage device 242) is characterized by a resonant frequency: a first resonant frequency (ω₁) for the first energy-storage device 232 and a second resonant frequency (ω₂) for the second energy-storage device 234. An energy-storage device (e.g., a resonator device) is enabled to store a range of energies based on its resonant frequency. In some embodiments, the range of energies that a resonator device is enabled to store may be centered about its resonant frequency. In some embodiments, the first resonance frequency and the second resonant frequency may be equivalent or similar frequencies. In other embodiments, the first resonant frequency (e.g., of the first and the second resonant frequency may be dissimilar frequencies.

In some embodiments, the switching devices (e.g., first switching device 234 and/or the second switching device 244) may be a superconducting quantum interference device (SQUID) coupler, e.g., a radiofrequency (RF) SQUID coupler. Thus, the first switching device 234 may be a first SQUID coupler (e.g., a first RF SQUID coupler) and the second switching device 244 may be a second SQUID coupler (e.g., a second RF SQUID coupler). Other embodiments are not so limited, and the switching devices may be any device that can selectively electrically couple respective energy-storage device and the transmission line 222. That is, a switching device may serve as an active switch (or gate) between the transmission line 222 and the switching device's corresponding energy-storage device. For instance, as a switching device is switched to a “closed” mode of operation (or alternatively when the gate is “opened”), the closed switching device electrically couples the transmission line 222 and the switch's corresponding electrical-storage device. In switching devices (e.g., the first switching device 234 and/or the second switching device 244), when the switching device is “switched” (or “tuned”) to the “closed” operating mode, the transmission line 222 and the corresponding energy-storage device are electrically coupled. Thus, when the switch is closed, energy stored in the energy-storage device may be transferred to the transmission line 222.

A signal (carrying the previously-stored energy) may be transmitted along the transmission line 222 and absorbed via the ground source 214 (or another element that is enabled to absorb and dissipate heat associated with the previously stored energy). In various embodiments, the ground source may include a heat-sinking device (e.g., a resistor as shown in FIG. 2) to absorb and/or dissipate thermal energy associated with the stored energy (e.g., the signal). When the switching device is switched (or tuned) to be turned “opened,” the respective energy-storage device and the transmission line 222 are electrically decoupled. Thus, any energy stored in the respective energy-storage device remains (at least temporally) stored in the respective energy-storage device. Accordingly, a switching device may serve functionally as a transistor (or transistor-like device). When a switching device is switched “closed,” energy (in the form of an electrical signal) may flow between the respective energy-storage device and the transmission line 222. When the switching device is switched “open,” energy may be inhibited flowing between the respective energy-storage device and the transmission line 222.

Because an electrical coupling between the transmission line 222 and the energy-storage devices may be tuned (or switched) “on” or “off,” the switching devices may be referred to as tunable-coupling (or tunable-coupler) devices. In such nomenclature, when the tunable-coupling device is tuned (or turned) “on,” the electrical coupling between the transmission line 222 and the energy-storage devices is enabled. When the tunable-coupling device is tuned (or turned) “off,” the electrical coupling between the transmission line 222 and the energy-storage devices is disabled. Thus, in the embodiments, a switching device may be an active device that enables the selective electrical coupling and decoupling of the transmission line 222 and the energy-storage devices. Note that in FIG. 2, the electrical coupling and decoupling between the transmission line 222 and the energy-storage devices is achieved via mutual inductance, the embodiments are not so limited to inductive coupling. For instance, some embodiments may employ transistors (e.g., field effect transistors (FETs)) as switching devices.

In SQUID coupler embodiments, each SQUID coupler (e.g., first switching device 234 and second switching device 244) may be switched “closed” via the transmission of a signal (e.g., a control signal) flowing along the transmission line 222. For instance, such a signal may be transmitted along the transmission line 222, via turning “on” the bias source 212, setting up a voltage difference between the bias source 212 and the ground source 214. The control signal may switch the switching device “closed” via an inductive coupling between the transmission line 222 and the switching device. For instance, the first switching device 234 may be switched “closed” via the control signal (transmitted on the transmission line 222) propagating to the first switching device 234 by the inductive coupling between the first inductor 226 (of the transmission line 222) and the second inductor 236 (of the first switching device 234). There may be a first mutual inductance (M₁) between the transmission line 222 and the first switching device 234. The first switching device 234 is switched “open” when the control signal is absent along the transmission line 222. Likewise, the second switching device 244 may be switched “closed” via the control signal (transmitted on the transmission line 222) propagating to the second switching device 244 by the inductive coupling between the third inductor 228 (of the transmission line 222) and the fourth inductor 246 (of the second switching device 244). There may be a second mutual inductance (M₂) between the transmission line 222 and the second switching device 244. The second switching device 244 is switched “open” when the control signal is absent along the transmission line 222. Thus, each switching device inductively tied to the transmission line 222 may be switched “closed” simultaneously via a single control signal transmitted along the transmission line 222 (e.g., via aa potential difference across the bias source 212 and the ground source 214). Likewise, each switching device inductively tied to the transmission line 222 may be switched “open” simultaneously via the cessation of the transmission of the control signal along the transmission line 222.

When running a QEC code, at least a subset of the set of qubits (e.g., the measure qubits) will need to be periodically reset to its ground state (e.g., 0>). A qubit in an excited state (e.g., |1>, 2>, |3>, and the like) may be reset to its ground state as discussed below. In the following discussion describing resetting a qubit in an excited state, it is assumed that the qubit's quantum state is the first excited state (e.g., |1>), and resetting the qubit involves transition the qubit's quantum state from the first excited state to the ground state. However, when the qubit is in a leakage state (e.g., an excited state that is greater than its first excited state), such as |2>, 3>, 4>, and the like, this process may be performed multiple times, until the qubit reaches its ground state. For example, assume that the quantum state of the qubit is |n>, where n is an integer and n≥2. The following process may be performed, such that the qubit's quantum state is transitioned to |n−1>. The process can then be repeated until the qubit's quantum state is its ground state.

The qubits of the set of qubits may be tunable qubits, in that the operating frequency of the qubit may be tuned. Tuning a qubit to a particular frequency may be accomplished by sending the qubit a tuning signal. The tuning signal may be characteristic of the qubit frequency that the qubit is to be tuned to. To simplify FIG. 2, the tuning signals for the qubits are not shown in FIG. 2. To reset a qubit from an excited state (e.g., |1>). to its ground state, the qubit may be tuned to a frequency that is similar to the resonant frequency of its corresponding energy-storage device.

A qubit may be tuned to the corresponding resonant by sending the qubit a tuning signal that tunes the frequency of the qubit. When a qubit is in its first excited state (e.g., 1>). the qubit's frequency is tuned to a frequency that is similar to the resonant frequency of the qubit's corresponding energy-storage device (e.g., a resonator), the qubit may transfer a quantum of energy to the corresponding energy-storage device. The quantum of energy transferred may be equivalent to the difference in energy between the qubit's first excited state and the qubit's ground state. Upon the transfer of the quantum of energy, the qubit's quantum state is transitioned from the first excited state to the ground state. Thus, the qubit has been reset to its ground state.

The quantum of energy transferred to the energy-storage device may be temporarily stored in the energy-storage device. To dissipate the energy (and not significantly heat up the semiconductor substrate 220), the stored energy may be transferred to the ground source (or another heat-absorbing element inside or outside of the cryogenic chamber 210) by switching the corresponding switching device closed. As described above, all of the switching devices along the transmission line 22 may be simultaneously switch closed by a single control signal transmitted along the transmission line 222. After the stored energy has been dissipated, the switching devices may be switched open by terminating the transmission of the control signal along the transmission line 222. As noted above, if the quantum state of the qubit is in a leakage state, this process may be repeated

Accordingly, QCS 200 may execute a quantum algorithm by employing the set of qubits. While executing the quantum algorithm, a QEC code may be implemented. While implementing the QEC code, a subset of the set of qubits may be employed as measure (or ancilla) qubits. For instance, the first qubit 230 may be a first measure (or ancilla) qubit and the second qubit 240 may be a second measure (or ancilla) qubit. Implementing the QEC code may include the QCS 200 performing a first stabilizer measurement that employs the first qubit 230 as the first measure qubit and performing a second stabilizer measurement that employs the second qubit 240 as the second measure qubit. The QCS may then reset the first qubit 230 and reset the second qubit 240 to their ground states.

More particularly, to reset the first qubit 230 to its ground state, the first qubit 230 is tuned to a first frequency associated with the first energy-storage device 232 (e.g., the resonant frequency of the first energy-storage device 232). When the first qubit 230 is in a first higher-energy state (e.g., |1>). and the first qubit 230 is tuned to the first frequency, the first qubit 230 is transitioned from the first higher-energy state to a first lower-energy state (e.g., |0>). A first quantum of energy may be transferred from the first qubit 230 to the first energy-storage device 232. The first quantum of energy is stored in the first energy-storage device 232. An energy difference between the first higher-energy state and the first lower-energy state may be equivalent to the first quantum of energy.

To reset the second qubit 240 to its ground state, the second qubit 240 is tuned to a second frequency associated with the second energy-storage device 242 (e.g., the resonant frequency of the second energy-storage device 242). When the second qubit 240 is in a second higher-energy state (e.g., |1>). and the second qubit 240 is tuned to the second frequency, the second qubit 240 is transitioned from the second higher-energy state to a second lower-energy state (e.g., |0>). A second quantum of energy may be transferred from the second qubit 240 to the second energy-storage device 242. The second quantum of energy is stored in the second energy-storage device 242. An energy difference between the second higher-energy state and the second lower-energy state may be equivalent to the first quantum of energy.

The first quantum of energy (stored in the first energy-storage device 232) and the second quantum of energy (stored in the second energy-storage device 242) may be carried away from the semiconductor substrate 220 and dissipated such as to not heat up the semiconductor substrate 220 by transmitting a first signal (e.g., a control signal) along the transmission line 222. Transmitting the first signal along the transmission line 222 electrically couples the first switching device 234 and the transmission line 22 such that the first energy quantum of energy stored in the first energy-storage device 232 is transferred from the first energy-storage device 232 to the transmission line 222. A second signal transmitted along the transmission line 222 transmits the first quantum of energy away from the first energy-storage device 232 and away from the first switching device 234. Transmitting the first signal along the transmission line 222 additionally electrically couples the second switching device 244 and the transmission line 222 such that the second quantum of energy stored in the second energy-storage 242 device is transferred from the second energy-storage device 242 to the transmission line 222. A third signal transmitted along the transmission line 222 transmits the second quantum of energy away from the second energy-storage device 242 and away from the second switching device 244.

Thus, the QCS 200 may include a semiconductor substrate 220. The semiconductor substrate 220 (and thus the QCS 200) may include a transmission line 222, a first energy-storage device 232, and a first qubit 230. The 232 first energy-storage device is configured to store a first range of energies based on a first frequency (e.g., a resonant frequency of the first energy-storage device 232) that characterizes the first energy-storage device 232. The first qubit 230 is electrically coupled to the first energy-storage device 232. When a quantum state of the first qubit 230 is equivalent to a second state (e.g., a first excited state of the first qubit 230) and the first qubit 230 is tuned in accordance with the first frequency, a first quantum of energy is transferred from the first qubit 230 to the first energy-storage device 232. The first energy-storage device 232 stores the first quantum of energy. The quantum state of the first qubit 230 may be transitioned from the second state to a first state (e.g., a ground state of the first qubit 230). An energy difference between the second state and the first state is equivalent to the first quantum of energy. The first switching device 234 is electrically coupled to the first energy-storage device 232. When the first switching device 234 is tuned to a first operational state (e.g., a closed state), the first energy-storage device 232 is further electrically coupled to the transmission line 222 such that the first quantum of energy stored by the first energy-storage device 232 is transferred to the transmission line 222. When the first switching device 232 is tuned to a second operational state (e.g., an open state), the first energy-storage device 232 is electrically decoupled from the transmission line 222.

The semiconductor substrate 220 (and thus the QCS 200) may further include a second-energy-storage device 242, a second qubit 240, and a second switching device 244. The second energy-storage device 242 is configured to store a second range of energies based on a second frequency (e.g., a resonant frequency of the second energy-storage device 242) that characterizes the second energy-storage device 242. The second qubit 240 is electrically coupled to the second energy-storage device 242. When a quantum state of the second qubit 240 is equivalent to a fourth state (e.g., a first excited state of the second qubit 240) and the second qubit 240 is tuned in accordance with the second frequency, a second quantum of energy is transferred from the second qubit 240 to the second energy-storage device 242. The second energy-storage device 242 stores the second quantum of energy. The quantum state of the second qubit 240 may be transitioned from the fourth state to a third state (e.g., a ground state of the second qubit 240). An energy difference between the fourth state and the third state is equivalent to the second quantum of energy. The second switching device 244 is electrically coupled to the second energy-storage device 242. When the second switching device 244 is tuned to a first operational state (e.g., the closed state), the second energy-storage device 242 is further electrically coupled to the transmission line 222 such that the second quantum of energy stored by the second energy-storage device 242 is transferred to the transmission line 222. When the second switching device 242 is tuned to the second operational state (e.g., the open state), the second energy-storage device 242 is electrically decoupled from the transmission line 222.

In some embodiments, the second frequency is a different frequency than the first frequency. A first signal (e.g., a control signal) may be transmitted along the transmission line 222. The control signal simultaneously transitions both the first switching device 234 and the second switching device 244 from the second operational state to the first operational state. A second signal transmitted along the transmission line 222 transmits the first quantum of energy away from the first energy-storage device 232 and away from the first switching device 234. A third signal transmitted along the transmission line 222 transmits the second quantum of energy away from the second energy-storage device 242 and away from the second switching device 244.

In various embodiments, the first switching device 234 is a first superconducting quantum interference device (SQUID) coupler. The second switching device 244 may be a second SQUID coupler. The first energy-storage device 232 may be a first resonator and the first frequency may be a resonant frequency of the first resonator. The second energy-storage device 242 may be a second resonator and the second frequency may be a resonant frequency of the second resonator. In some embodiments. The transmission line 222, the first energy-storage device 232, the first qubit 230, and the first switching device 234 may be integrated on the semiconductor substrate 220. The second energy-storage device 242, the second qubit 240, and the second switching device 244 may also be integrated on the semiconductor substrate 220. The first qubit 230 may be capacitively coupled to the first energy-storage device 232 via a first capacitor 238. The second qubit 240 may be capacitively coupled to the second energy-storage device 242 via a second capacitor 248.

In various embodiments, the QCS 200 includes the ground source 214. The ground source 214 may be positioned away from the semiconductor substrate 220. The transmission line 222 may be electrically coupled to the ground source 214. The transmission line 222 may be configured to transmit the second signal that carries the first quantum of energy away from away from the first energy-storage device 232 and away from the first switching device 234. The second signal may also transmit the first quantum of energy away from the semiconductor substrate 220 and to the ground source 214. The transmission line 222 may be further configured to transmit the third signal that carries the second quantum of energy away from away from the second energy-storage device 242 and away from the second switching device 244. The third signal may also transmit the second quantum of energy away from the semiconductor substrate 220 and to the ground source 214. The QCS 200 may also include the cryogenic chamber 210. The cryogenic chamber may house the semiconductor substrate 220.

As shown in FIG. 2, the transmission line 222 may include a first inductor 226. The first switching device 234 includes a second inductor 236. The first inductor 226 and second inductor 236 form an inductive coupling between the transmission line 222 and the first switching device 234. Transmitting a first signal on the transmission line 222 tunes the first switching device 234 to the first operational state (e.g., the closed state) via the inductive coupling between the transmission line 222 and the first switching device 234. When the transmission line 222 does not transmit the first signal, the first switching device 234 is tuned to the second operational state (e.g., the open state). The transmission line 222 may further include a third inductor 228. The second switching device 244 includes a fourth inductor 246. The third inductor 228 and fourth inductor 246 form an inductive coupling between the transmission line 222 and the second switching device 244. Transmitting the first signal on the transmission line 222 also tunes the second switching device 244 to the first operational state via the inductive coupling between the transmission line 222 and the second switching device 244. When the transmission line 222 does not transmit the first signal, the second switching device 244 is tuned to the second operational state (e.g., the open state). The transmission line 222 further transmits the second signal that carries the first quantum of energy away from the first energy-storage device 232 and the first switching device 234. The transmission line 222 also transmits the third signal that carries the second quantum of energy away from the second energy-storage device 242 and away from the second switching device 244.

### Example Methods

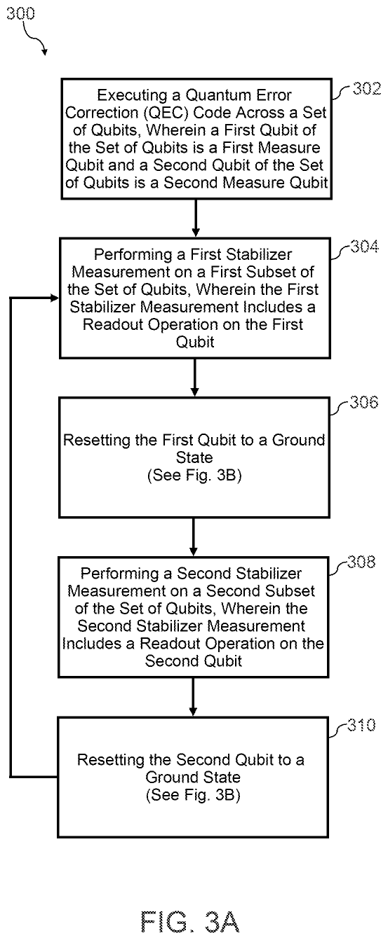

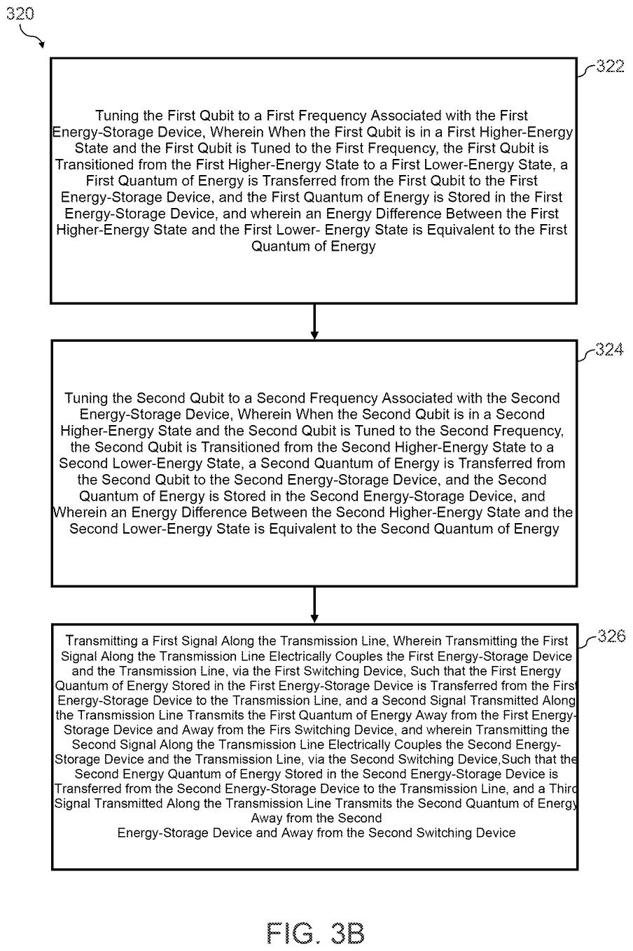

FIG. 3A depicts a flow chart diagram of an example method 300 for operating a quantum computing system (QCS), according to example embodiments of the present disclosure. The QCS may be similar to QCS 200 of FIG. 2. Accordingly, the QCS includes a set of physical qubits that includes at least a first qubit and a second qubit. The QCS may further include a first energy-storage device that is electorally coupled to the first qubit and a second energy-storage device that is electrically coupled to the second qubit. The QCS may further include a first switching device that is electrically coupled to the first energy storage device and a second switching device that is electrically coupled to the second energy-storage device. The QCS may also include a transmission line. Although FIG. 3A depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At block 302, a quantum error correction (QEC) code may be implemented by the QCS, and across the set of qubits. The first qubit may be a first measure (or ancilla) qubit of the QEC code. The second qubit may be a second measure (or ancilla) qubit of the QEC code. At block 304, a first stabilizer measurement may be performed on a first subset of the set of qubits. The first subset of qubits includes at least the first qubit. The first stabilizer measurement includes a readout operation of the first qubit. At block 306, the first qubit may be reset to a ground state. Various embodiments of resetting a qubit to its ground state are discussed in conjunction with at least method 320 of FIG. 3B. At block 308, a second stabilizer measurement may be performed on a second subset of the set of qubits. The second subset of qubits includes at least the second qubit. The second stabilizer measurement includes a readout operation of the second qubit. At block 310, the second qubit may be reset to a ground state. Various embodiments of resetting a qubit to its ground state are discussed in conjunction with at least method 320 of FIG. 3B. Note that in some embodiments, block 308 may be performed in conjunction with the performance of block 304. Likewise, block 310 may be performed in conjunction with the performance of block 306.

FIG. 3B depicts a flow chart diagram of an example method 320 for resetting a first qubit and a second qubit to their ground states, according to example embodiments of the present disclosure. Method 320 may be implemented by a quantum computing system (QCS), such as but not limited to QCS 200 of FIG. 2. At block 322, the first qubit is tuned to a first frequency associated with the first energy-storage device. When the first qubit is in a first higher-energy state and the first qubit is tuned to the first frequency, the first qubit is transitioned from the first higher-energy state to a first lower-energy state. A first quantum of energy may be transferred from the first qubit to the first energy-storage device. The first quantum of energy may be stored in the first energy-storage device. An energy difference between the first higher-energy state and the first lower-energy state may be equivalent to the first quantum of energy.

At block 324, the second qubit is tuned to a second frequency associated with the second energy-storage device. When the second qubit is in a second higher-energy state and the second qubit is tuned to the second frequency, the second qubit is transitioned from the second higher-energy state to a second lower-energy state. A second quantum of energy may be transferred from the second qubit to the second energy-storage device. The second quantum of energy may be stored in the second energy-storage device. An energy difference between the second higher-energy state and the second lower-energy state may be equivalent to the second quantum of energy.

At block 326, a first signal is transmitted along the transmission line. Transmitting the first signal along the transmission line electrically couples the first energy-storage device and the transmission line, via the first switching device. The first energy quantum of energy stored in the first energy-storage device is transferred from the first energy-storage device to the transmission line. A second signal is transmitted along the transmission line. The second signal transmits the first quantum of energy away from the first energy-storage device and away from the first switching device. Transmitting the first signal along the transmission line additionally electrically couples the second energy-storage device and the transmission line, via the second switching device. The second quantum of energy stored in the second energy-storage device is transferred from the second energy-storage device to the transmission line. A third signal is transmitted along the transmission line. The third signal transmits the second quantum of energy away from the second switching device and away from the second switching device.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A quantum computing system comprising:
a transmission line;
a first energy-storage device that is configured to store a first range of energies based on a first frequency that characterizes the first energy-storage device;
a first qubit that is electrically coupled to the first energy-storage device, wherein when a quantum state of the first qubit is equivalent to a second state and the first qubit is tuned in accordance with the first frequency, a first quantum of energy is transferred from the first qubit to the first energy-storage device, which stores the first quantum of energy, and the quantum state of the first qubit is transitioned from the second state to a first state, wherein an energy difference between the second state and the first state is equivalent to the first quantum of energy; and
a first switching device electrically coupled to the first energy-storage device, wherein when the first switching device is tuned to a first operational state, the first energy-storage device is further electrically coupled to the transmission line such that the first quantum of energy stored by the first energy-storage device is transferred to the transmission line, and when the first switching device is tuned to a second operational state, the first energy-storage device is electrically decoupled from the transmission line.

2. The quantum computing system of claim 1, wherein the first switching device is superconducting quantum interference device (SQUID) coupler.

3. The quantum computing system of claim 1, wherein the first energy-storage device is a resonator and the first frequency is a resonant frequency of the resonator.

4. The quantum computing system of claim 1, further comprising:
a semiconductor substrate, wherein the transmission line, the first energy-storage device, the first qubit, and the first switching device are integrated on the semiconductor substrate.

5. The quantum computing system of claim 4, further comprising:
a ground source positioned away from the semiconductor substrate, wherein the transmission line is electrically coupled to the ground source and configured to transmit a signal that carries the first quantum of energy away from the semiconductor substrate and to the ground source.

6. The quantum computing system of claim 4, further comprising:
a cryogenic chamber that houses the semiconductor substrate.

7. The quantum computing system of claim 1, wherein the transmission line includes a first inductor, the first switching device includes a second inductor, and the first and second inductors form an inductive coupling between the transmission line and the first switching device.

8. The quantum computing system of claim 7, wherein transmitting a first signal on the transmission line tunes the first switching device to the first operational state via the inductive coupling between the transmission line and the first switching device and when the transmission line does not transmit the first signal, the first switching device is tuned to the second operational state.

9. The quantum computing system of claim 8, wherein the transmission line further transmits a second signal that carries the first quantum of energy away from the first energy-storage device and away from the first switching device.

10. The quantum computing system of claim 1, wherein the first qubit is capacitively coupled to the first energy-storage device via a first capacitor.

11. The quantum computing system of claim 1, further comprising;
a second energy-storage device that is configured to store a second range of energies based on a second frequency that characterizes the second energy-storage device;
a second qubit that is electrically coupled to the second energy-storage device, wherein when a quantum state of the second qubit is equivalent to a fourth state and the second qubit is tuned in accordance with the second frequency, a second quantum of energy is transferred from the second qubit to the second energy-storage device, which stores the second quantum of energy, and the quantum state of the second qubit is transitioned from the fourth state to a third state, wherein an energy difference between the fourth state and the third state is equivalent to the second quantum of energy; and
a second switching device electrically coupled to the second energy-storage device, wherein when the second switching device is tuned to the first operational state, the second energy-storage device is further electrically coupled to the transmission line such that the second quantum of energy stored by the second energy-storage device is transferred to the transmission line, and when the second switching device is tuned to the second operational state, the second energy-storage device is electrically decoupled from the transmission line.

12. The quantum computing system of claim 11, wherein the second frequency is a different frequency than the first frequency, a first signal transmitted along the transmission line simultaneously transitions both the first switching device and the second tunable coupling-device from the second operational state to the first operational state, a second signal transmitted along the transmission line transmits the first quantum of energy away from the first energy-storage device and away from the first switching device, and a third signal transmitted along the transmission line transmits the second quantum of energy away from the second energy-storage device and away from the second switching device.

13. A method for operating a quantum computing system (QCS), wherein the QCS includes a first qubit, a first energy-storage device electrically coupled to the first qubit, a first switching device electrically coupled to the first energy-storage device, and a transmission line, the method comprising:
tuning the first qubit to a first frequency associated with the first energy-storage device, wherein when the first qubit is in a first higher-energy state and the first qubit is tuned to the first frequency, the first qubit is transitioned from the first higher-energy state to a first lower-energy state, a first quantum of energy is transferred from the first qubit to the first energy-storage device, and the first quantum of energy is stored in the first energy-storage device, and wherein an energy difference between the first higher-energy state and the first lower-energy state is equivalent to the first quantum of energy; and
transmitting a first signal along the transmission line, wherein transmitting the first signal along the transmission line electrically couples the first energy-storage device and the transmission line, via the first switching device, such that the first energy quantum of energy stored in the first energy-storage device is transferred from the first energy-storage device to the transmission line, and a second signal transmitted along the transmission line transmits the first quantum of energy away from the first energy-storage device and away from the first switching device.

14. The method of claim 13, wherein the first switching device is superconducting quantum interference device (SQUID) coupler.

15. The method of claim 13, wherein the first energy-storage device is a resonator and the first frequency is a resonant frequency of the resonator.

16. The method of claim 13, wherein the QCS further includes a second qubit, a second energy-storage device electrically coupled to the second qubit, and a second switching device coupled to the second energy-storage device, the method further comprising:
tuning the second qubit to a second frequency associated with the second energy-storage device, wherein when the second qubit is in a second higher-energy state and the second qubit is tuned to the second frequency, the second qubit is transitioned from the second higher-energy state to a second lower-energy state, a second quantum of energy is transferred from the second qubit to the second energy-storage device, and the second quantum of energy is stored in the second energy-storage device, and wherein an energy difference between the second higher-energy state and the second lower-energy state is equivalent to the second quantum of energy; and
transmitting the first signal along the transmission line, wherein transmitting the first signal along the transmission line electrically couples the second energy-storage device and the transmission line, via the second switching device, such that the second quantum of energy stored in the second energy-storage device is transferred from the second energy-storage device to the transmission line, and a third signal transmitted along the transmission line transmits the second quantum of energy away from the second switching device and away from the second switching device.

17. A semiconductor substrate comprising:
a transmission line;
a first energy-storage device that is configured to store a first range of energies based on a first frequency that characterizes the first energy-storage device;
a first qubit that is electrically coupled to the first energy-storage device, wherein when a quantum state of the first qubit is equivalent to a second state and the first qubit is tuned in accordance with the first frequency, a first quantum of energy is transferred from the first qubit to the first energy-storage device, which stores the first quantum of energy, and the quantum state of the first qubit is transitioned from the second state to a first state, wherein an energy difference between the second state and the first state is equivalent to the first quantum of energy; and
a first switching device electrically coupled to the first energy-storage device, wherein when the first switching device is tuned to a first operational state, the first switching device electrically couples the first energy-storage device and the transmission line such that the first quantum of energy stored by the first energy-storage device is transferred to the transmission line, and when the first switching device is tuned to a second operational state, the first switching device electrically decouples the first energy-storage device and the transmission line.

18. The semiconductor substrate of claim 17, wherein the first switching device is superconducting quantum interference device (SQUID) coupler.

19. The semiconductor device of claim 17, wherein the first energy-storage device is a resonator and the first frequency is a resonant frequency of the resonator.

20. The semiconductor device of claim 7, further comprising;
a second energy-storage device that is configured to store a second range of energies based on a second frequency that characterizes the second energy-storage device.
a second qubit that is electrically coupled to the second energy-storage device, wherein when a quantum state of the second qubit is equivalent to a fourth state and the second qubit is tuned in accordance with the second frequency, a second quantum of energy is transferred from the second qubit to the second energy-storage device, which stores the second quantum of energy, and the quantum state of the second qubit is transitioned from the fourth state to a third state, wherein an energy difference between the fourth state and the third state is equivalent to the second quantum of energy; and
a second switching device electrically coupled to the second energy-storage device, wherein when the second switching device is tuned to the first operational state, the second switching device electrically couples the second energy-storage device and the transmission line such that the second quantum of energy stored by the second energy-storage device is transferred to the transmission line, and when the second switching device is tuned to the second operational state, the second switching device electrically decouples the second energy-storage device and the transmission line.
